(19) United States
(12) Patent Application Publication
(10) Pub. No.: US 2023/0406572 A1
(43) Pub. Date: Dec. 21, 2023

(54) CONFIGURABLE CAPACITY GRID TRAY FOR ROBOT PART HANDLING

(71) Applicant: Hurco Companies Inc., Indianapolis, IN (US)

(72) Inventors: Paul J. Gray, Zionsville, IN (US); David William Lopossa, Indianapolis, IN (US)

(21) Appl. No.: 17/844,895

(22) Filed: Jun. 21, 2022

(51) Int. Cl. B65D 25/06; B65D 25/10

(52) U.S. Cl. CPC B65D 25/06; B65D 25/107

(57) ABSTRACT

A configurable tray for robot workpiece handling, comprises: a frame including frame segments arranged in a rectangle, each including a plurality of positioning features spaced evenly along an inner edge of the frame segment; and a plurality of separation bars configured to be selectively positioned within the frame to define one or more configurable grid patterns of pockets for receiving a workpiece by selectively positioning a first number of the plurality of separation bars between positioning features of a first pair of opposed frame segments and selectively positioning a second number of the plurality of separation bars overlapping the first number of the plurality of separation bars between positioning features of a second pair of opposed frame segments, the first pair of segments being perpendicular to the second pair of segments.

### FIELD OF THE DISCLOSURE

The present disclosure relates generally to trays for robot part handling and more particularly to grid trays that are configurable to provide various grid patterns for positioning workpieces.

### BACKGROUND

It is known to automatically “pick and place” workpieces from a workpiece tray to a holding fixture (such as a vice or chuck) in a machine tool (such as a CNC machine) using a robotic arm. FIG. 1 shows a typical robotic machine tending system 10 which generally includes a robot 12 controlled by a controller and having grippers 16 for gripping a workpiece. Robotic machine tending systems generally require the workpieces be presented in a part tray 18 in a regular array for robot 12 to pick from programmatically and systematically. The sequence typically begins with robot 12 picking a workpiece 27 from a fixed-array grid tray 18 such as that depicted in FIG. 2 and opening a CNC auto door 20. If there is a completed part 374 in the holding fixture 22, typically a second gripper removes that part first and then loads the new workpiece 27 into holding fixture 22. After the workpiece is loaded, robot 12 exits the CNC machine 24, auto door 20 closes, and CNC machine 24 starts machining. Robot 12 then places the finished part 374 back into its original place in grid tray 18 or alternatively into a separate finished parts bin. Following that, robot 12 picks up the next workpiece 27 to machine and waits for CNC machine 24 to finish machining the current part, and the process repeats until machining of all of the parts is complete.

The purpose of arranging the workpieces 27 in a regular array in grid tray 18 is to simplify programming of robot 12 and to separate the parts to provide space for the gripper fingers 26 to access the workpieces 27 without interfering with neighboring workpieces. The regular array provides a simple way for operators to load grid tray 18 and accurately place the workpieces for robot 12, which is critical to ensure that robot 12 loads the workpiece 27 into holding fixture 22 (e.g., a pneumatic vise) accurately for machining. The operator loads grid tray 18 by placing a workpiece 27 in a pocket 28 and pushing the workpiece to a corner of pocket 28, which ensures the workpiece is accurately placed in each pocket 28. The process is simple and does not require precise locating and alignment by the operator to fill grid tray 18.

The main limitation of the fixed-array grid tray concept is that it is limited to one pocket dimension and is only optimized for a single size of workpieces. Most conventional grid trays are not configurable to accept workpieces of different sizes. To optimize the capacity for different sized workpieces, each workpiece size requires a different fixed-array grid tray to be designed for the pocket size to match the part size closely, manufactured, installed, and calibrated. Similarly, if a subsequent manufacturing job's workpieces are larger than the pocket dimensions of the current grid tray, then a new grid tray with larger pockets would need to be manufactured.

One existing grid tray 30 design that permits optimization of workpiece capacity of a fixed surface area provides an array of peg or tapped holes 31 as shown in FIG. 3. This design allows the operator to place workpieces 27 in a regular array that can be changed to hold workpieces of different sizes. The pegs 32 (FIG. 4) can be added, removed, and moved according to the workpiece dimensions required. However, these designs are costly to manufacture and, for rectangular workpieces, require at least three pegs 32 to lock the workpiece position and orientation (only two pegs 32 are required for circular workpieces 34 as shown in FIG. 4). Manually setting the pegs 32 in the tray 30 for each workpiece size/shape is exceedingly cumbersome, making workpiece change overs labor intensive and tedious.

While it is possible to carefully position workpieces 27 on a part tray surface that has been laser engraved or otherwise marked with a regular array of grid lines using the grid lines as a guide, such an approach would require far more time and precision work by the operator to load workpieces 27 than a conventional grid tray design. Moreover, any mistake in the positioning a workpiece 27 may result in a collision with robot gripper 16.

It is also possible to achieve variable capacity by eliminating the fixed array approach entirely. Instead, in robotic bin picking, for example, as shown in FIG. 5, vision systems are used wherein a camera 36 or set of cameras are either mounted to the wrist of a robot 12 or on a frame 38 external to the robot 12 to detect the location of workpieces 27 in a bin 40 or on a conveyor or table. The vision system is taught the workpiece geometry by taking multiple images of the workpiece. Additionally, the robot 12 is taught where to grip the workpiece 27 and how to approach and then retract after picking the workpiece. When workpieces 27 are presented to the robot system, the camera 36 is used to detect the location and orientation of workpieces. A robotic path is automatically generated and executed such that the robot 12 picks a workpiece 27 directly. These systems are typically very expensive, complex, and time consuming to setup and program. Also, they are considerably less reliable than presenting the robot 12 with a regular array of workpieces. Furthermore, their part cycle times can be slow as they will generally need a re-grip station where the robot 12 releases the workpiece 27 in a fixture and regrips it a second time in a more accurate fixed location before attempting to load the workpiece 27 in a holding fixture 22 of the CNC machine 24. Hence, these systems are more commonly used for sorting and other similar tasks as opposed to CNC machine tending.

### SUMMARY

According to one embodiment, the present disclosure provides a configurable tray for robot workpiece handling, comprising: a frame including a plurality of frame segments arranged in a rectangle, each of the plurality of frame segments including a plurality of positioning features spaced evenly along an inner edge of the frame segment; and a plurality of separation bars, each separation bar including a first end and a second end and configured to be selectively positioned within the frame such that the first end is positioned at a positioning feature of one of the frame segments and the second end is positioned at a positioning feature of another of the frame segments opposite the one of the frame segments; wherein the plurality of separation bars are configured to be positioned to define one or more configurable grid patterns of pockets for receiving a workpiece by selectively positioning a first number of the plurality of separation bars between positioning features of a first pair of opposed frame segments of the plurality of frame segments and selectively positioning a second number of the plurality of separation bars overlapping the first number of the plurality of separation bars between positioning features of a second pair of opposed frame segments of the plurality of frame segments, the first pair of segments being perpendicular to the second pair of segments. In one aspect of this embodiment, the plurality of positioning features each includes a notch disposed between adjacent protrusions formed along the inner edge of the segment of the frame. Another aspect of this embodiment further includes a base, the frame being attached to the base. In a variant of this aspect, the base includes a pair of end plates and a plurality of inner plates. In a further variant, the pair of end plates and the plurality of inner plates are configured to interlock to form the base. In another aspect of this embodiment, the plurality of frame segments includes a pair of side segments and a pair of end segments. In a variant of this aspect, each of the pair of side segments includes a first end forming a first notch and a second end forming a second notch, and each of the pair of end segments includes a first end forming a first tab and a second end forming a second tab, the first notches being configured to mate with the first tabs and the second notches being configured to mate with the second tabs, thereby connecting the pair of side segments to the pair of end segments to form the frame. Yet another aspect of this embodiment further includes a pair of locking plates, each locking plate being attached to one of the plurality of frame segments and including an inner portion that overlaps the ends of the second number of the plurality of separation bars to clamp the plurality of separation bars in place. A variant of this aspect further includes a base attached to the frame and including a pair of end plates and a plurality of inner plates, wherein the plurality of frame segments, the plurality of separation bars, the pair of end plates, the plurality of inner plates, and the pair of locking plates are substantially the same length and substantially the same width. Still another aspect of this embodiment further includes a plurality of height adjustment brackets and a plurality of clips, wherein each height adjustment bracket is positioned adjacent a corner of the frame and includes a plurality of horizontal slots, and each of the plurality of clips is configured to extend through a pair of the plurality of horizontal slots and clip onto a frame segment, thereby supporting the frame at a selectable height above a support surface. In a variant of this aspect, each of the plurality of height adjustment brackets includes a mounting plate configured to attach to the support surface and an upright plate including the plurality of horizontal slots.

In another embodiment, the present disclosure provides a robotic machine tending system, comprising: a robot having at least one gripper for gripping a workpiece; a controller configured to execute job manager software to control movement of the robot; and a configurable tray configured to hold workpieces in one or more grid patterns of pockets; wherein the configurable tray comprises: a frame including a plurality of frame segments including a plurality of positioning features spaced evenly along an inner edge of the frame segment; and a plurality of separation bars configured to be selectively positioned within the frame to define the one or more grid patterns of pockets by selectively positioning a first number of the plurality of separation bars between positioning features of a first pair of opposed frame segments of the plurality of frame segments and selectively positioning a second number of the plurality of separation bars overlapping the first number of the plurality of separation bars between positioning features of a second pair of opposed frame segments of the plurality of frame segments, the first pair of frame segments being perpendicular to the second pair of frame segments. In one aspect of this embodiment, the plurality of positioning features each includes a notch disposed between adjacent protrusions formed along the inner edge of the frame segment. In another aspect, the configurable tray further includes a base, the frame being attached to the base. In a variant of this aspect, the base includes a pair of end plates and a plurality of inner plates, the pair of end plates and the plurality of inner plates being configured to interlock to form the base. In yet another aspect, the plurality of frame segments includes a pair of side segments and a pair of end segments configured to mate with the pair of side segments to form the frame. In still another aspect of this embodiment, the configurable tray further includes a pair of locking plates, each locking plate being attached to one of the plurality of frame segments and including an inner portion that overlaps ends of the second number of the plurality of separation bars to clamps the plurality of separation bars in place. In a variant of this aspect, the configurable tray further includes a base attached to the frame and including a pair of end plates and a plurality of inner plates, wherein the plurality of frame segments, the plurality of separation bars, the pair of end plates, the plurality of inner plates, and the pair of locking plates are substantially the same length and substantially the same width. In another aspect of this embodiment, the configurable tray further includes a plurality of height adjustment brackets and a plurality of clips, wherein each height adjustment bracket is positioned adjacent a corner of the frame and includes a plurality of horizontal slots, and each of the plurality of clips is configured to extend through a pair of the plurality of horizontal slots and clip onto a frame segment, thereby supporting the frame at a selectable height above a support surface. In still another aspect, the job manager software causes the controller to display one or more grid tray configuration screens to enable an operator to define a number of rows and a number of columns corresponding to each of the one or more grid patterns. In a variant of this aspect, the one or more configuration screens further enable the operator to define a length and a width of each of the one or more grid patterns. In another variant, the one or more configuration screens further enable the operator to define pockets of each of the one or more grid patterns that cannot be accessed by the robot.

In yet another embodiment, the present disclosure provides a method for configuring a tray for robot workpiece handing, comprising: selectively positioning a first plurality of separation bars within a corresponding first plurality of evenly spaced positioning features formed on a first pair of opposing frame segments of a frame; selectively positioning a second plurality of separation bars within a corresponding second plurality of evenly spaced positioning features formed on a second pair of opposing frame segments of the frame, the second pair of opposing frame segments being perpendicular to the first pair of frame segments and the second plurality of separation bars overlapping the first plurality of separation bars; and attaching a pair of locking bars to the second pair of opposing frame segments such that the locking bars overlap ends of the second plurality of separation bars to clamp the second plurality of separation bars in place. One aspect of this embodiment further comprises: assembling a base including a pair of end plates and a plurality of inner plates configured to interlock to form the base; and attaching the frame to the base. In a variant of this aspect, attaching the frame to the base includes positioning the frame above the base and securing the frame to a plurality of height adjustment brackets connected to the base using a plurality of clips.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a perspective view of a robotic machine tending system;

FIG. 2 is a perspective view of a conventional grid tray;

FIG. 3 is a perspective view of another conventional grid tray;

FIG. 4 is another perspective view of the conventional grid tray of FIG. 3;

FIG. 5 is a perspective view of a conventional vision system for robotic bin picking;

FIG. 6 is a top plan view of a configurable grid tray according to one embodiment of the present disclosure;

FIG. 7 is a perspective view of a configurable grid tray according to another embodiment of the present disclosure;

FIG. 8 is an enlarged, perspective view of a portion of the configurable grid tray of FIG. 7;

FIG. 9 is an exploded, perspective view of the configurable grid tray of FIG. 7;

FIG. 10 is a perspective view of an inner plate of a base of the configurable grid tray of FIG. 7;

FIGS. 11 and 12 are perspective views of a configurable grid tray according to another embodiment of the present disclosure;

FIG. 13 is a perspective view of a configurable grid tray according to the present disclosure positioned in a drawer of a robot station;

FIG. 14 is a perspective view of a configurable grid tray according to the present disclosure positioned on a table of a robot station;

FIG. 15 is a perspective view of a configurable grid tray according to the present disclosure positioned on an angled support surface of a robot station;

FIG. 16 is a screenshot configured to permit an operator to define of a configurable grid tray according to the present disclosure;

FIG. 17 is another screenshot configured to permit an operator to define of two grid patterns on a configurable grid tray according to the present disclosure;

FIG. 18 is a perspective view of a configurable grid tray according to the present disclosure on a table of a robot station;

FIGS. 19 and 20 are perspective views of a configurable grid tray according to the present disclosure in a drawer of a robot station;

FIG. 21 is a perspective view of a configurable grid tray according to the present disclosure;

FIGS. 22 and 23 are screenshots configured to permit an operator to define of a configurable grid tray according to the present disclosure; and

FIG. 24 is a perspective view of a configurable grid tray according to the present disclosure on a table of a robot station and configured to provide a plurality of different grid patterns of pockets for positioning workpieces.

While the present disclosure is amenable to various modifications and alternative forms, specific embodiments have been shown by way of example in the drawings and are described in detail below. The present disclosure, however, is not to limit the particular embodiments described. On the contrary, the present disclosure is intended to cover all modifications, equivalents, and alternatives falling within the scope of the appended claims.

### DETAILED DESCRIPTION OF EMBODIMENTS OF THE DISCLOSURE

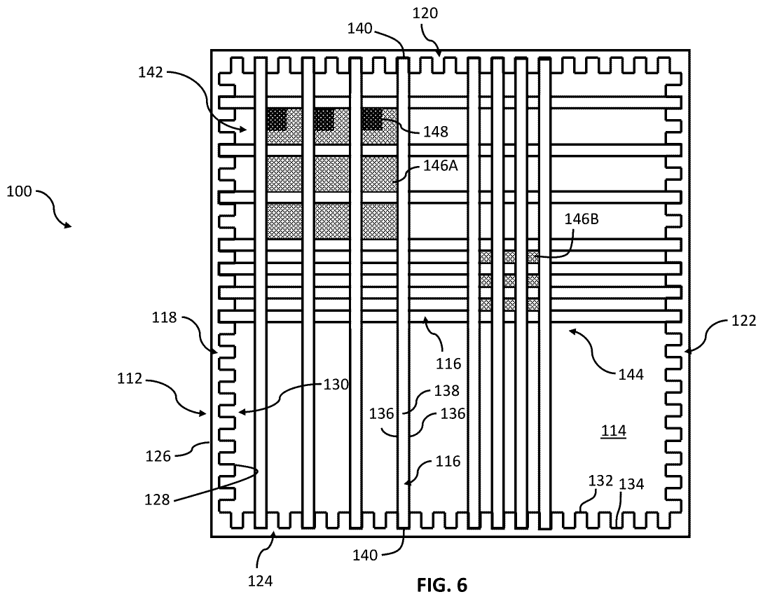

Referring now to FIG. 6, the basic design of a configurable grid tray according to the teachings of the present disclosure is shown. Grid tray 100 generally includes a frame 112 mounted on a base 114 and configured to receive a plurality of separation bars 116. In the example shown, frame 112 includes four side segments 118-124 arranged to form a rectangle. Each side segment 118-124 includes an outer edge 126 and an inner edge 128 having a plurality of bar positioning features 130. In this example, bar positioning features 130 include equally spaced protrusions 132 that define notches 134 between adjacent protrusions 132. It should be understood, however, that bar positioning features 130 may have a wide variety of configurations. For example, notches 134 may be curved or formed as recesses, protrusions 132 may extend upwardly (i.e., out of the page) rather than having a surface in plane with the upper surface of side segments 118-124, notches 134 may be omitted and protrusions 132 may be pegs configured to pass through corresponding openings in the ends of separation bars 116. Alternatively, notches 134 and protrusions 132 may be omitted and replaced with equally spaced magnets or magnetized portions of side segments 118-124. Other configurations are contemplated by the present disclosure. In any such variation, bar positioning features 130 are configured to accurately position separation bars 116 at any of a plurality of equally spaced locations along the length of side segments 118-124.

Frame 112 may be formed as an integral part of base 114. Alternatively, frame 112 may be attached to base 114 using fasteners, welding, adhesive, clamps, or any other type of attachment mechanism. Base 114 may be a rectangular, solid piece of material sized to correspond to outer edges 126 of side segments 118-124 of frame 112. Alternatively, base 114 may have openings formed therethrough or be formed using interlocking segments as described below. In certain embodiments, base 114 may be omitted entirely when, for example, frame 112 is attached to another support surface such as a table.

Separation bars 116 are depicted as elongated strips of material having straight, parallel side edges 136, a straight upper surface 138, a straight lower surface (not shown) that is parallel to upper surface 138, and a pair of ends 140. In one embodiment, the height of side edges 136 is smaller than the width of upper surface 138 and lower surface. In the depicted embodiment, each separation bar 116 is identical to the others. As should be apparent from the foregoing, the ends 140 of separation bars 116 are configured to mate with or otherwise be accurately positioned by bar positioning features 130 of side segments 118-124 of frame 112. In the example shown, separation bars 116 are positioned onto frame 112 horizontally first, and then additional separation bars 116 are positioned onto frame 112 vertically such that they overlap the horizontally positioned separation bars 116. In this manner, separation bars 116 may be positioned to form one or more regular grid patterns such as grid pattern 142 and grid pattern 144 in the example shown. Of course, separation bars 116 may be positioned to form a single grid pattern that spans all or part of base 114 within frame 112. In an alternative embodiment, separation bars 116 may be replaced with narrow rods laid on top of racks commonly found in rack-and-pinion gear sets or even timing belts which provide regular indentations to position the rods.

By positioning separation bars 116 in the manner described above, a plurality of pockets 146 may be formed in a regular grid pattern that facilitates efficient operation and programming of robot 12. For example, grid pattern 142 includes nine equally spaced, rectangular pockets 146A in a three-by-three grid. Grid pattern 144 also includes nine equally spaced, rectangular pockets 146B in a three-by-three grid, although pockets 146B are smaller than pockets 146A and formed to position smaller workpieces.

Regardless of the size of the pocket or workpiece, in this example each workpiece 148 may be precisely and easily located on grid tray 100 by registering the workpiece in a corner of the pocket 146. As an example, in grid pattern 142 three workpieces 148 are shown registered against the upper left corner of pockets 146A such that workpieces 148 are aligned and equally spaced from one another as is provided by conventional, non-configurable grid trays described above.

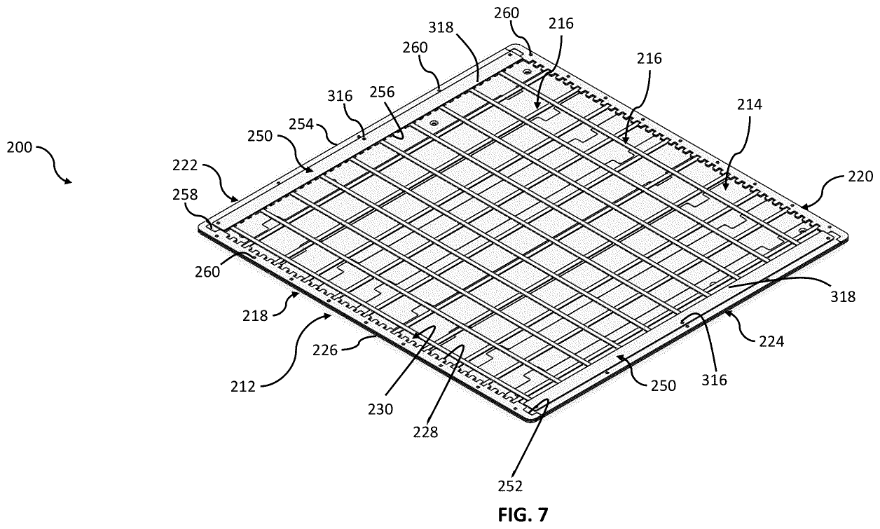

Referring now to FIGS. 7-9, another embodiment of a grid tray is shown. Like grid tray 100, grid tray 200 generally includes a frame 212, a base 214 and a plurality of separation bars 216. Separation bars 216 are the same as separation bars 116 described above with reference to grid tray 100. However, in grid tray 200, frame 212 and base 214 are formed using multiple components as is further described below. Additionally, grid tray 200 also includes a pair of locking plates 250 as is further described below.

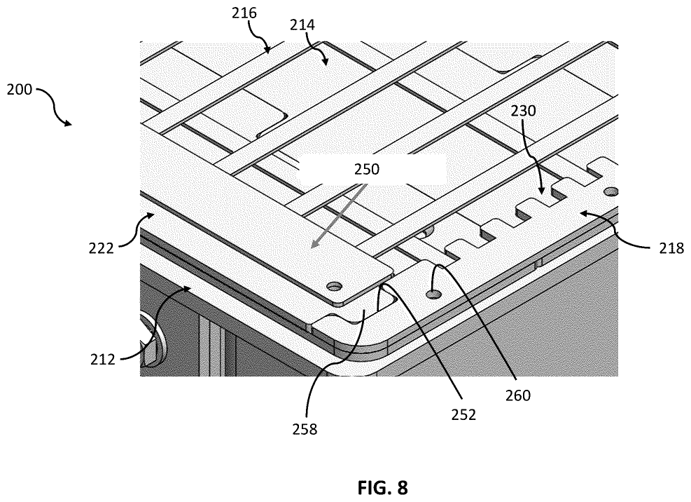

Frame 212 includes two side segments 218, 220 and two end segments 222, 224. Each side segment 218, 220 includes an outer edge 226 and an inner edge 228 having a plurality of bar positioning features 230 which are the same or similar to bar positioning features 130 described above with reference to grid tray 100. Each side segment 218, 220 also includes a notch 252 formed near each end of the segment along inner edge 228. Each end segment 222, 224 includes an outer edge 254 and an inner edge 256 having a plurality of bar positioning features 230 as described above with reference to grid tray 100. Each end segment 222, 224 also includes a tab 258 extending from each end of the segment and sized to mate with notches 252 of side segments 218, 220 as best shown in FIG. 8. In this manner, side segments 218, 220 and end segments 222, 224 may be assembled together to form frame 212. It should be understood that end segments 222, 224 may include notches 252 and side segments 218, 220 may include tabs 258, or any other mating structure may be used to align and connect side segments 218, 220 and end segments 222, 224. Each of side segments 218, 220 and end segments 222, 224 include a plurality of holes 260 configured to receive fasteners (not shown) to secure grid tray 200 to a support surface.

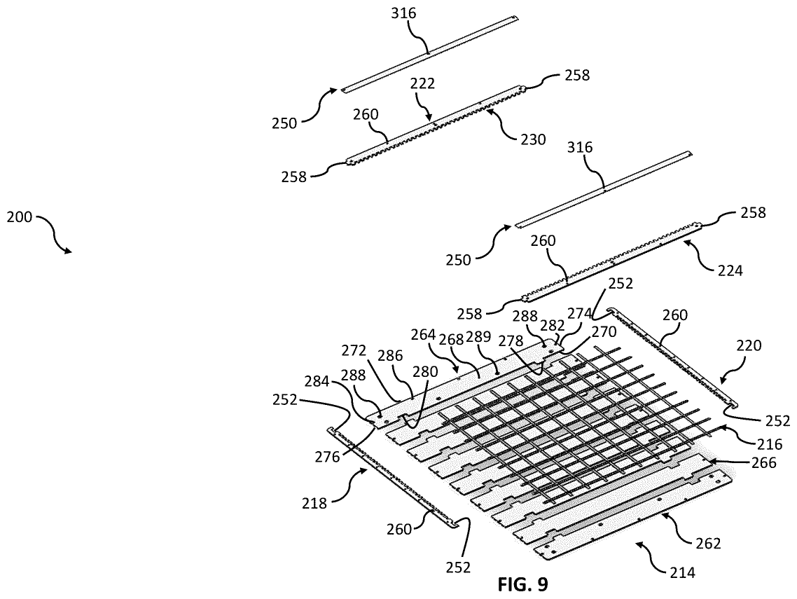

As best shown in FIG. 9, base 214 includes a pair of end plates 262, 264 and a plurality of inner plates 266. End plates 262, 264 are identical and only one is described herein. End plate 264 includes a body 268 with an inner edge 270, an outer edge 272, a first end edge 274 and a second end edge 276. A tab 278 is formed along inner edge 270 adjacent first end edge 274. A notch 280 is formed along inner edge 270 adjacent second end edge 276. An outer hole 282 is formed through end plate 264 adjacent first end edge 274 and is configured to receive a fastener (not shown) to connect side segment 220 to end plate 264. Similarly, an outer hole 284 is formed through end plate 264 adjacent second end edge 276 and is configured to receive a fastener (not shown) to connect side segment 218 to end plate 264. A plurality of holes 286 are formed through end plate 264 along outer edge 272 and are configured to receive fasteners to connect end segment 222 to end plate 264. A plurality of holes 288 are formed through end plate 264 between inner edge 270 and outer edge 272 and are configured to receive fasteners to connect locking plate 250 to end plate 264. Finally, a plurality of holes 289 are formed through end plate 264 adjacent edge 270 and are configured to receive fasteners to connect end plate 264 to robot station 336. As best shown in FIG. 9, tab 278 of end plate 264 is sized and positioned to be received by a mating notch formed along an edge of an inner plate 266 and notch 280 of end plate 264 is sized and positioned to receive a mating tab formed along an edge of an inner plate 266 as is further described below.

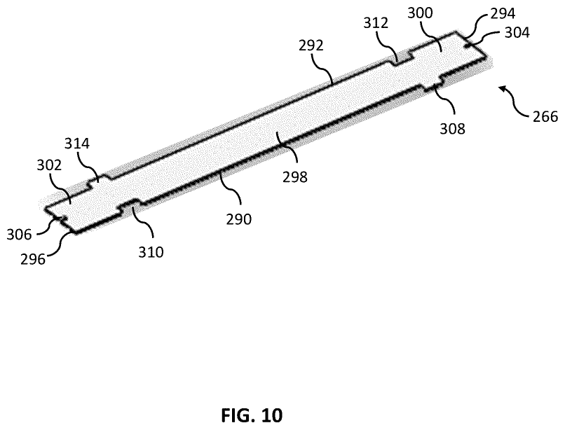

Referring now to FIG. 10, each inner plate 266 includes a first side edge 290, an opposite second side edge 292, a first end edge 294, a second end edge 296, a body portion 298, a first end portion 300 and a second end portion 302. First end portion 300 terminates at first end edge 294 and includes an opening 304 configured to receive a fastener (not shown) to secure inner plate 266 to one of side segments 218, 220. Second end portion 302 similarly terminates at second end edge 296 and includes an opening 306 configured to receive a fastener (not shown) to secure inner plate 266 to the other of side segments 218, 220. Between body portion 298 and first end portion 300, first side edge 290 forms a tab 308, and between body portion 298 and second end portion 302 first side edge 290 defines a notch 310. Similarly, between body portion 298 and first end portion 300 second side edge 292 defines a notch 312, and between body portion 298 and second end portion 302 second side edge 292 defines a tab 314. This configuration of inner plates 266 permits interlocking of inner plates 266 to form base 214 between end plates 262, 264. As should be apparent from the foregoing, any suitable interlocking structure may be used to connect or at least position inner plates 266 relative to one another.

Referring back to FIGS. 7-9, locking plates 250 are provided to secure separation bars 216 in their desired location. Locking plates 250 are formed as generally flat, elongated strips with a plurality of through-holes formed therethrough. After frame 212 and base 214 are assembled and connected together, separation bars 216 are placed into bar positioning features 230 in the manner described above to form one or more grid patterns for placement of workpieces 148. Finally, fasteners (not shown) are passed through openings 316 to attach locking plates 250 to end plates 222, 224 of base 214. An inner portion 318 of each locking plate 250 overlaps the ends of the upper plurality of separation bars 216 and clamps the upper separation bars 216 (and the lower plurality of separation bars 216 below the upper plurality of separation bars 216) in place. Consequently, grid tray 200 may be moved and/or reoriented without concern that separation bars 216 may fall out of position.

One benefit of the multi-piece design of grid tray 200 is the substantial uniformity of the size of the separate components. Each of side segments 218, 220 and end segments 222, 224 of frame 214, each of end plates 262, 264 and the plurality of inner plates 266 of base 214, separation bars 216 and locking plates 250 are elongated, substantially flat components of substantially the same length. As such, all of the components may be efficiently packaged together in a relatively small, densely packed container to minimize shipping costs.

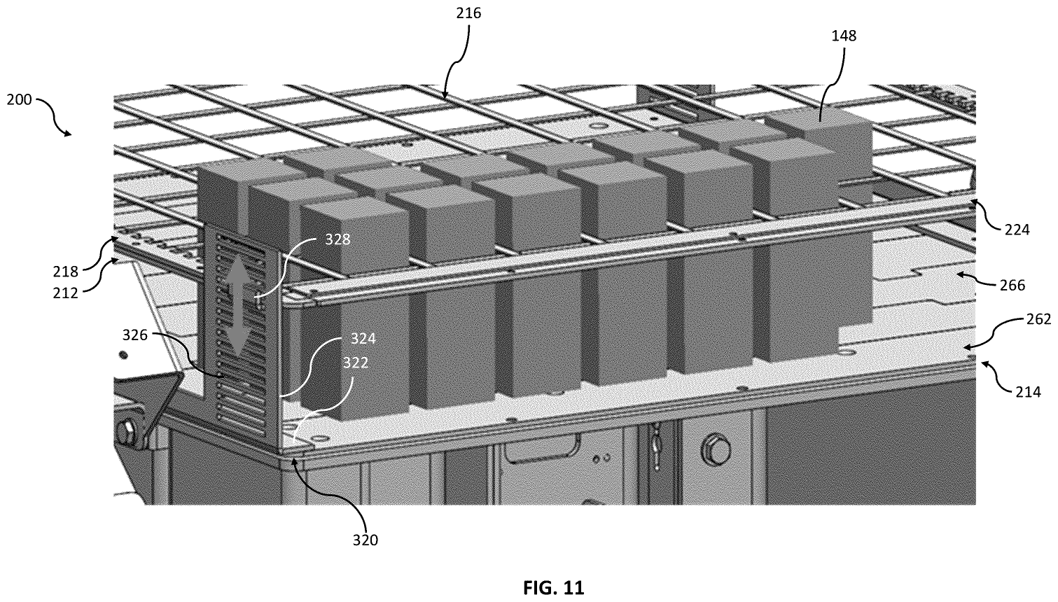

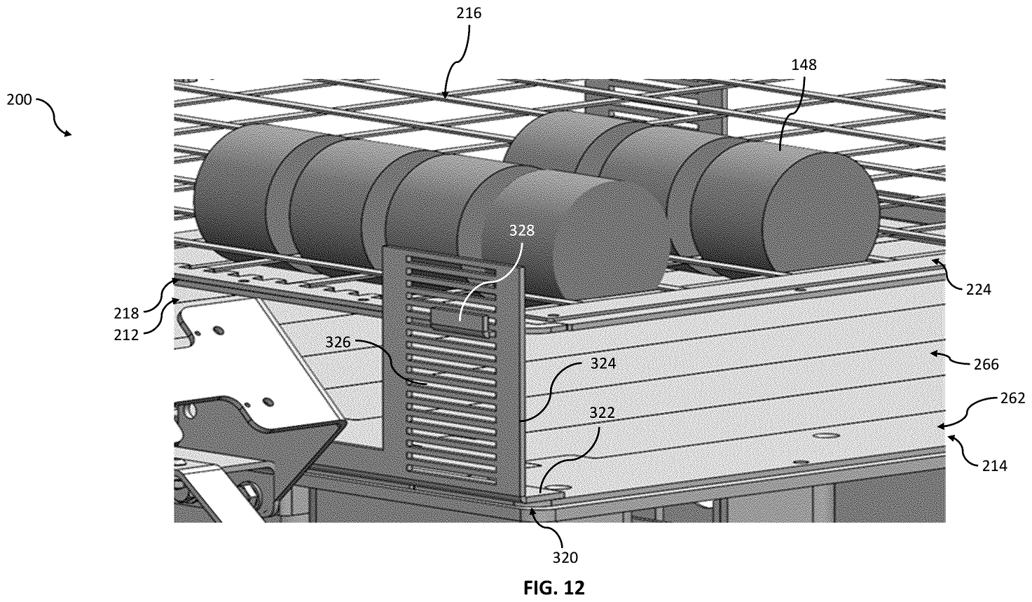

Yet a further embodiment of grid tray 200 is shown in FIGS. 11 and 12. In this embodiment, grid tray 200 further includes a plurality of height adjustment brackets 320 (only one shown) mounted to base 214 adjacent each corner of frame 212. In the example shown, each height adjustment bracket 320 includes a mounting plate 322 configured to attach to base 214 and an upright plate 324 extending perpendicularly from mounting plate 322. Upright plate 324 includes a plurality of horizontal slots 326 which are sized and spaced such that a clip 328 may be placed through any two adjacent slots 326 to clip onto frame 212 and support frame 212 at a selected height. By including such a height adjustment mechanism, grid tray 200 may be used to support taller workpieces 148 and provide better stability than a lower profile grid tray. Additionally, as depicted in FIG. 12, grid tray 200 with height adjustment brackets 320 may be used to support cylindrical workpieces 148 laying sideways. By raising frame 212 and separation bars 216 an appropriate height above base 214 using height adjustment brackets 320, grid tray 200 may be set up such that a portion of cylindrical workpieces 148 extend below separation bars 216 to precisely locate workpieces 148, while a main portion of the workpieces 148 extend above separation bars 216 to be gripped by robot 12.

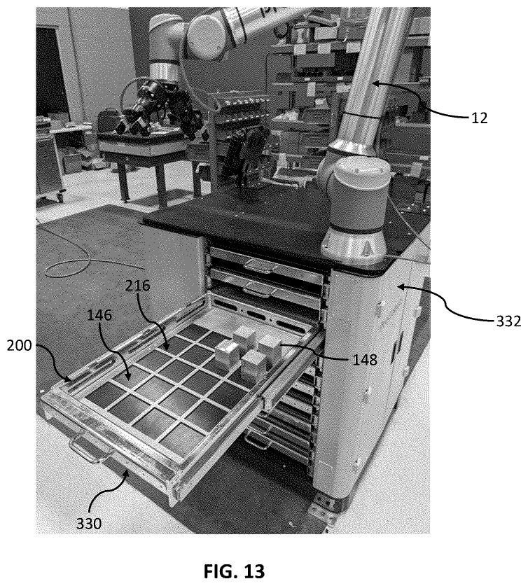

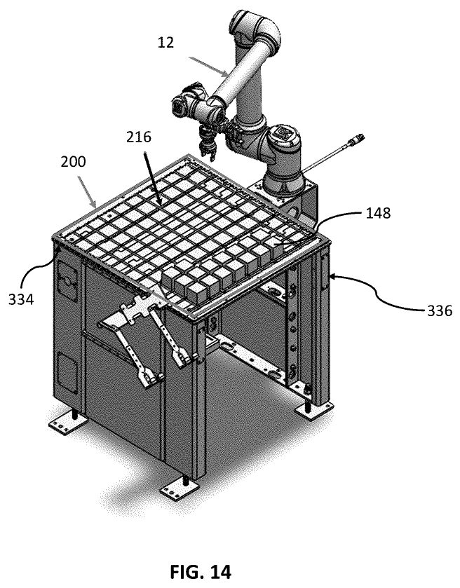

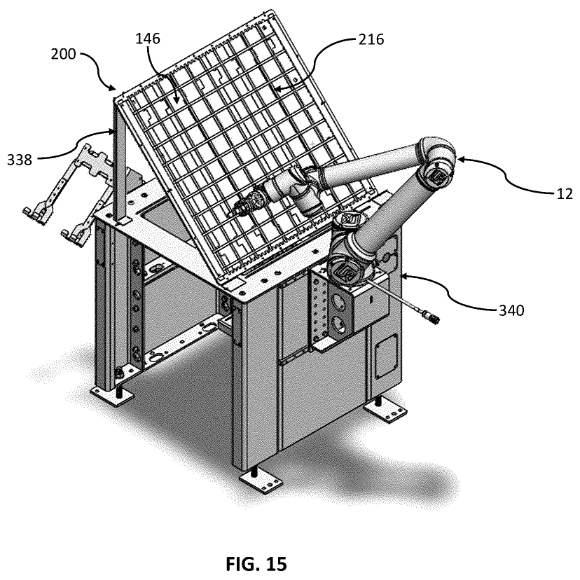

The embodiments of grid tray 100, 200 disclosed herein may be used in a variety of applications such as in drawer systems and table systems, or any other workpiece presentation surface. FIG. 13 depicts grid tray 200 disposed in a drawer 330 of a robot station 332. As shown, workpieces 148 are registered against the inner right corners of pockets 146 formed by separation bars 216. FIG. 14 depicts grid tray 200 disposed on top of a table 334 of a robot station 336. In yet another application depicted in FIG. 15, grid tray 200 is disposed on an angled support surface 338 of a robot station 340 such that the force of gravity ensures that workpieces 148 remain fixed in the desired locations in pockets 146.

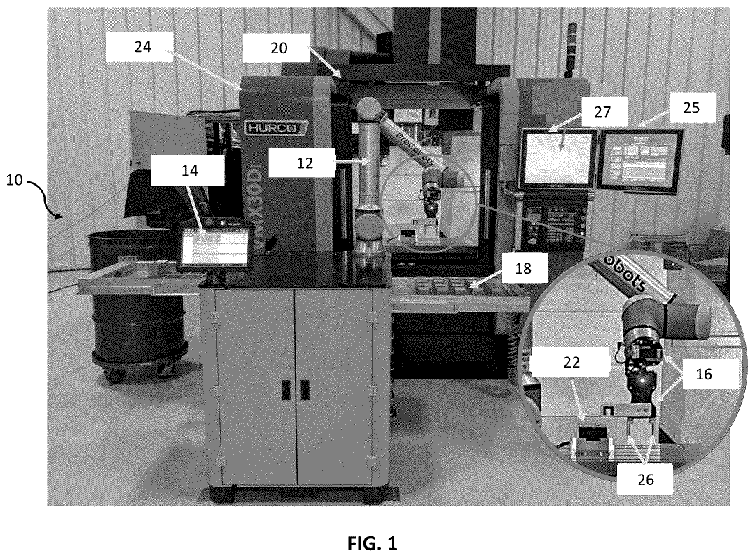

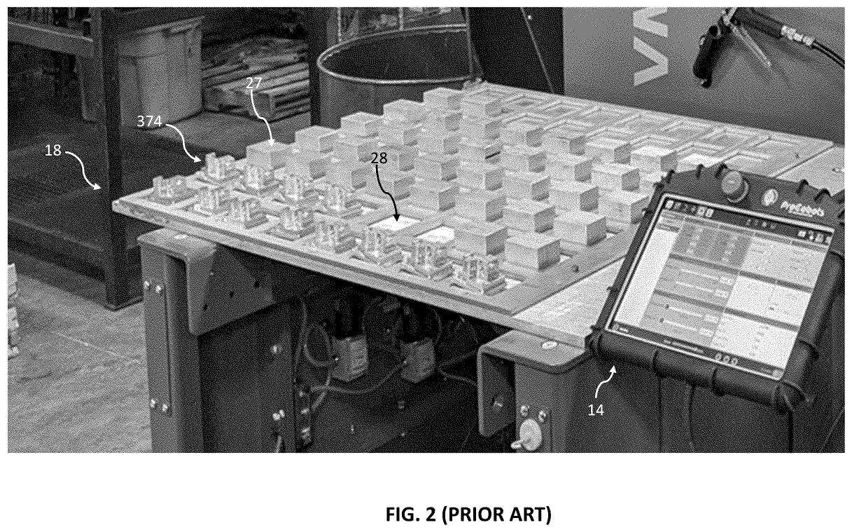

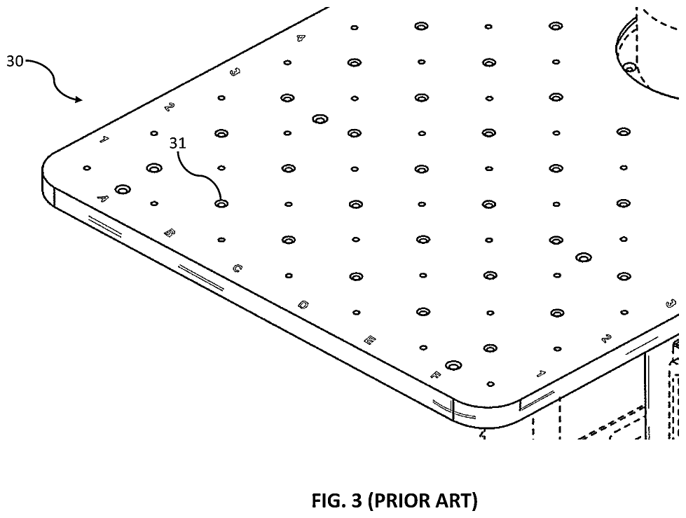

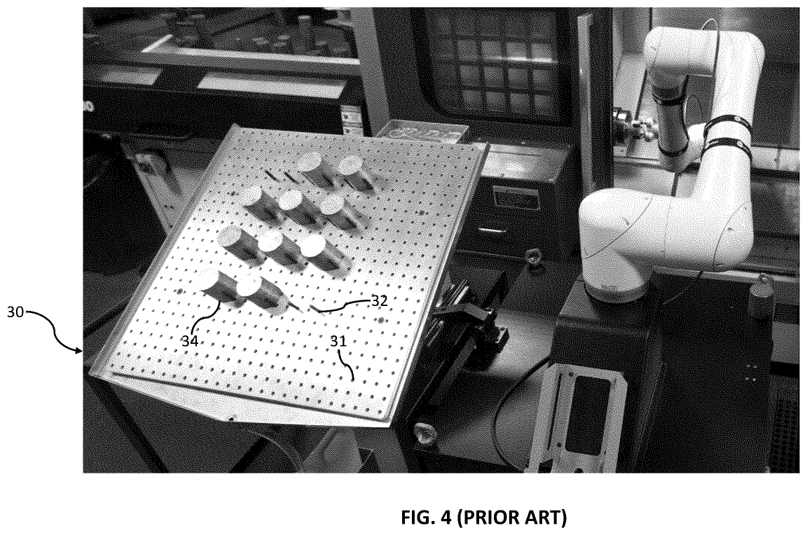

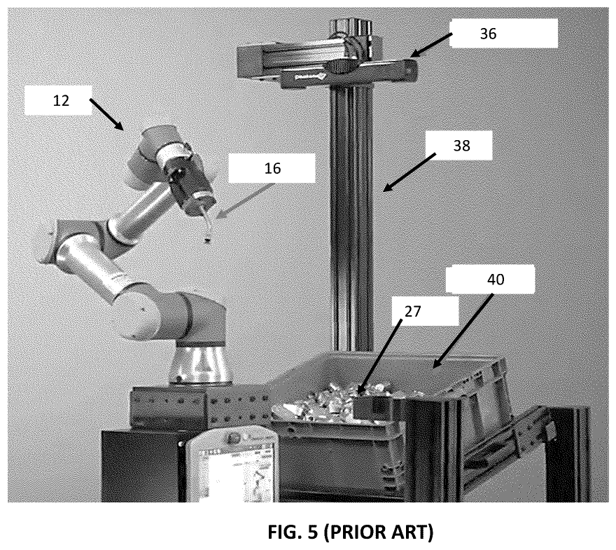

In certain embodiments, robot 12 is controlled to operate with configurable grid tray 200 by a job manager software control system (hereinafter, “job manager software”) executed by a controller, which could be a controller 25 of CNC machine 24 (FIG. 1), a separate computing device, or a controller of a teach pendant 14. Hereinafter, the job manager software is described as being executed by controller 25. It should be understood that the term controller 25 as used herein includes hardware and software and/or firmware comprising processing instructions executing on one or more programmable processors, application-specific integrated circuits, field-programmable gate arrays, digital signal processors, hardwired logic, or combinations thereof, which may referred to as “controllers.” Therefore, in accordance with the embodiments, various controllers may be implemented in any appropriate fashion and would remain in accordance with the embodiments herein disclosed. A non-transitory machine-readable memory 27 is accessed by controller 25 and comprises instructions for execution by controller 25. Memory can additionally be considered to be embodied within any tangible form of a computer-readable carrier, such as solid-state memory, containing an appropriate set of computer instructions and data structures that would cause controller 25 to carry out the techniques described herein. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

An operator can measure and store the calibration of grid tray 200 configuration using gripper fingers 26 of robot 12, for example, by measuring three corner points of grid tray 200 and adjusting the measured points based on the width and length of the fingers 26 which are used as the calibration device as described below. The robot end of arm position is computed using the joint encoder locations to calculate the three corner points relative to the robot base coordinate system.

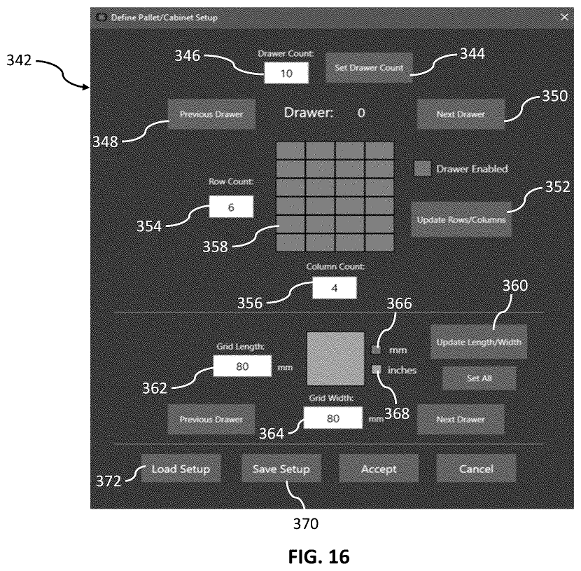

FIG. 16 depicts an interactive screenshot 342 generated by job manager software to permit configuration of grid tray 200 in a drawer system. It should be understood that screenshot 342 and other screenshots described herein may be used with drawer systems, table systems, or any other system for presenting workpieces 148. As shown, an operator may set the number of drawers by clicking on icon 344 and filling in field 346. The operator can navigate from one drawer configuration to another using icons 348, 350. By clicking icon 352 and filling in fields 354 and 356, the operator can input the number of rows and columns grid tray 200 has been configured to include. A depiction 358 of the physical grid tray 200 configuration is provided.

The operator can also update or define the actual length and width of pockets 146 of grid tray 200 by filling in fields 362 and 364 and clicking on icon 360. Boxes 366 and 368 permit the operator to input the grid dimensions in millimeters or inches, respectively. Finally, the operator may save the drawer configuration by clicking on icon 370 and proceed to define the next drawer. Icon 372 permits the operator to load a previously defined drawer configuration stored on memory accessible by controller 25.

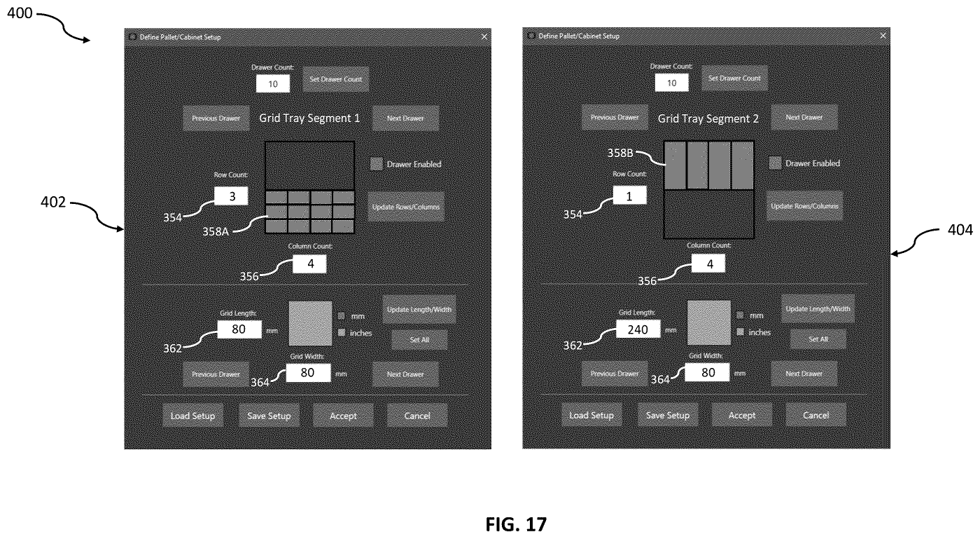

FIG. 17 illustrates another screenshot 400 generated job manager software which facilitates configuration of two grid patterns on the same grid tray 200 in the same drawer. As shown, the first grid pattern portion 402 of screenshot 400 has been completed to define a three row, four column grid pattern 358A having pockets 146 with an 80 mm length and an 80 mm width. The second grid pattern portion 404 of screenshot 400 has been completed to define a one row, four column grid pattern 358B have pockets 146 with a 240 mm length and an 80 mm width.

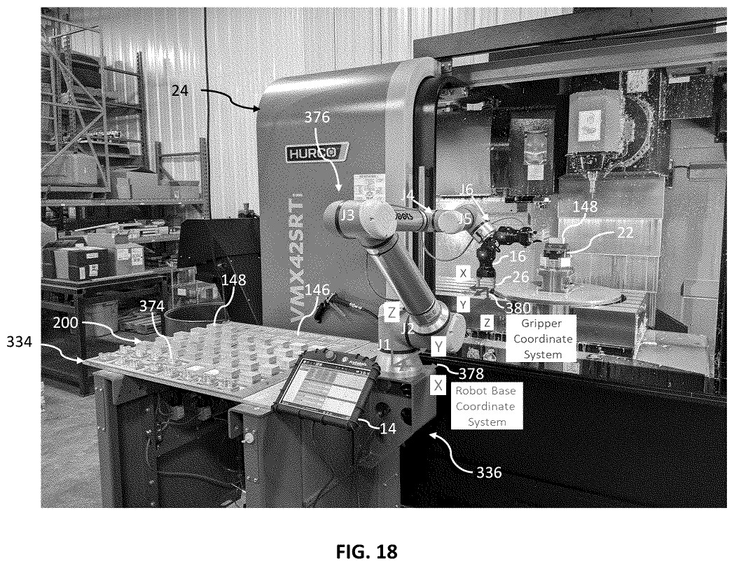

Referring now to FIG. 18, grid tray 200 is depicted in a table system such as that depicted in FIG. 14. In FIG. 18 grid tray 200 is disposed on top of table 334 of robot station 336 and is shown holding workpieces 148 and finished parts 374 in pockets 146. FIG. 18 further depicts an example robot 376 having six joints (J1-J6) which move robot 376 under control of controller 25 relative to robot base coordinate system 378 and a pair of grippers 16, each with a pair of fingers 26 that are movable relative to a gripper coordinate system 380. Robot station 336 is situated adjacent a CNC machine 24 having a holding fixture 22 configured to hold workpieces 148.

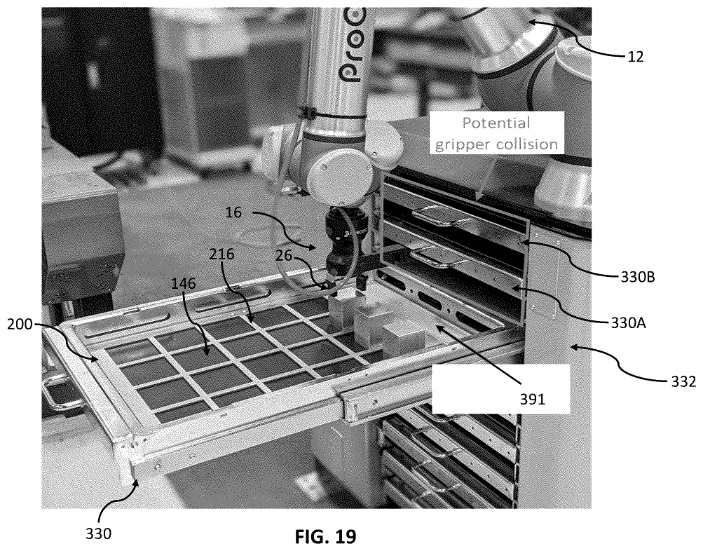

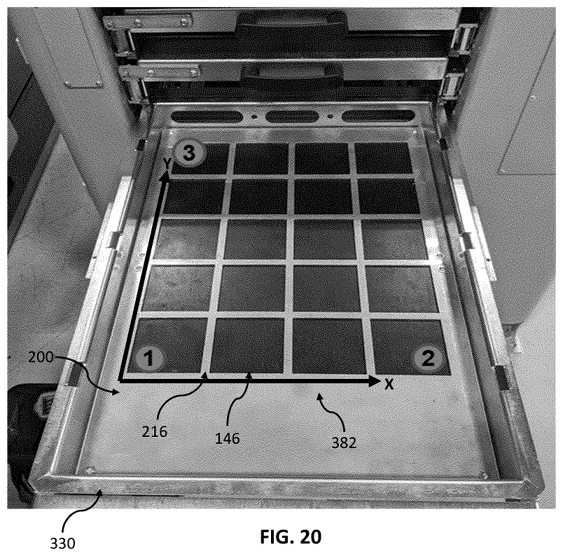

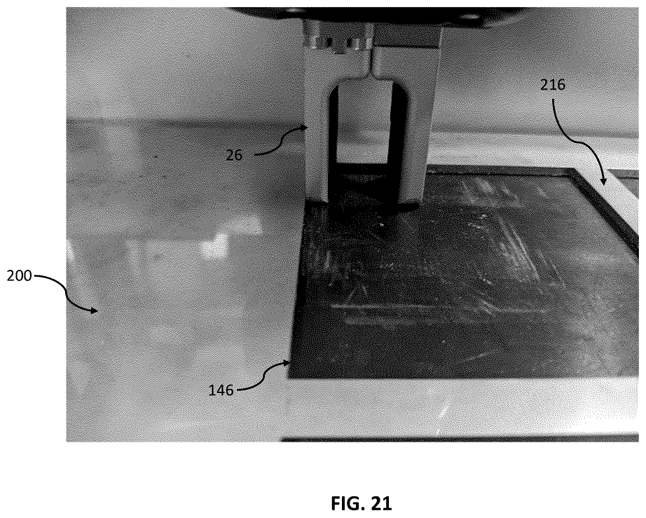

The three-corner point calibration discussed above is further described with reference to FIGS. 19-21. FIGS. 19 and 20 show grid tray 200 in drawer 330. In FIG. 20, the three corners of grid pattern 382 configured in grid tray 200 are labeled 1, 2 and 3. FIG. 21 shows gripper fingers 26 in contact with corner 3 of grid pattern 382. Calibration begins by guiding gripper 16 to each of the 3 corner points labeled in FIG. 20. For each corner, fingers 26 are aligned to the bottom of the pocket 146 such that gripper 16 is perpendicular to the plane of grid tray 200, and pressed to align to the edges of the pocket so that gripper 16 is lined up with the XY coordinate system shown in FIG. 20B that coincides with grid tray 200. Each position is stored and computed relative to the robot coordinate system 378 in FIG. 18. The stored positions however are the center of the gripper location and not the actual corners of grid tray 200. To compute the actual corner locations, the width and length of gripper fingers 26 are measured and divided by two to give the Finger Calibration Offset X and Y. Then, the directions of the X and Y vectors are computed from the three points with the following equations:

$${\vec{x}}_{d i r} = \frac{\vec{{P}_{2} - {P}_{1}}}{\vert \vec{{P}_{2} - {P}_{1}} \vert}$$

$${\vec{y}}_{d i r} = \frac{\vec{{P}_{3} - {P}_{1}}}{\vert \vec{{P}_{3} - {P}_{1}} \vert}$$

$$Finger Calibration {Offset}_{x} = \frac{Finger Width}{2}$$

$$Finger Calibration {Offset}_{y} = \frac{Finger Length}{2}$$

Corner1ₓ=P1ₓ−Finger Calibration Offsetₓ·\vec{x}_{dir}

Corner1_{y}=P1_{y}−Finger Calibration Offset_{y}·\vec{y}_{dir}

Corner2ₓ=P2ₓ+Finger Calibration Offsetₓ·\vec{x}_{dir}

Corner2_{y}=P2_{y}−Finger Calibration Offset_{y}·\vec{y}_{dir}

Corner3ₓ=P3ₓ−Finger Calibration Offsetₓ·\vec{x}_{dir}

Corner3_{y}=P3_{y}+Finger Calibration Offset_{y}·\vec{y}_{dir}

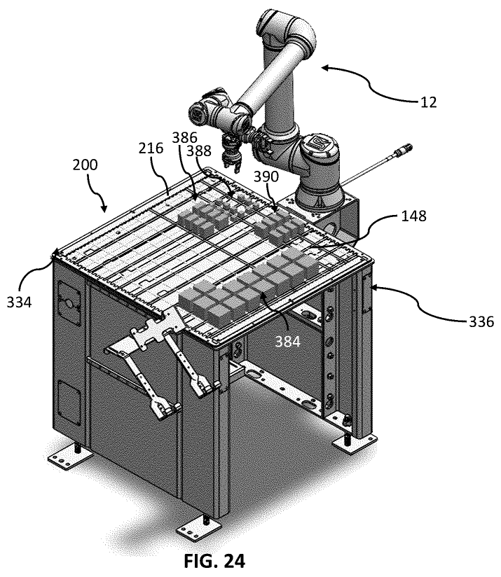

Knowing the directions for X and Y, the actual corners of grid tray 200 can be computed by adding and subtracting the width and length of fingers 26 for each of the three points in the corresponding X and Y directions. This gives the three corner points of grid tray 200 relative to the robot base coordinate system. Given the pocket width and length and the number of pockets in grid tray 200 shown in FIG. 16, controller 25 can compute the corner position for each pocket. Knowing the dimensions of workpieces 148 placed in pockets 146 such that they are pushed into the bottom corner of each pocket, controller 25 can compute where to position gripper 16 to pick up any part in grid tray 200. It should be understood that any calibration tool with fixed dimensions that would fit inside pocket 146 can be used as long as it is held rigidly or rigidly fixed to gripper 16 or robot end of arm in place of gripper fingers 26 if so desired. One example would be a cylindrical calibration tool. Another example would be gripping the actual workpiece material with gripper fingers 26. The calibration described herein is performed for each grid pattern configured in grid tray 200 (see FIG. 24 depicting multiple grid patterns including grid pattern 384, grid pattern 386, grid pattern 388 and grid pattern 390). By calibrating each grid pattern, controller 25 can compute the pick and place locations of robot 12 for every pocket according to the pocket dimensions and location and the workpiece 148 dimensions as described above.

Given the X and Y locations of each grid pattern of grid tray 200 and the number of pockets 146 in the rows and columns of each grid pattern, controller 25 can show the available pockets 146 and the operator can select to place workpieces 148 in the available pockets 146. This capability of setting the pocket sizes to different dimensions throughout grid tray 200 allows the operator to optimize the available surface area for different size workpieces 148 for unattended robot tending of different batches of workpieces 148.

According to one feature of the present disclosure, controller 25 permits the operator to define segments or pockets 146 that are not to be accessed to avoid interference between robot 12 and workpieces 148 or to avoid commanding robot 12 to access locations which cannot be reached by grippers 16 due to reach or other limitations in the robot's kinematics and gripper configuration. FIG. 19 depicts an example situation where a row 391 of pockets 146 cannot be accessed by gripper 16 because of the potential for collision with drawers 330A, 330B.

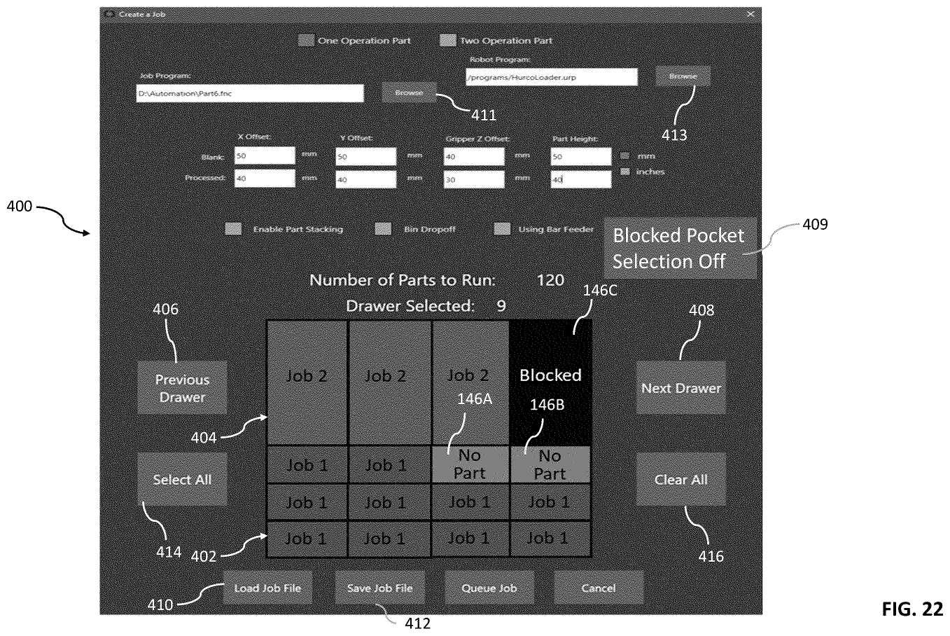

In situations such as depicted in FIG. 19, the operator can access a screen 400 generated by job manager software such as shown in FIG. 22 to define pockets 146 that are empty or should not be accessed. FIG. 22 shows screen 400, wherein a drawer 330 has been configured to include two different size workpieces 148 for different jobs (i.e., Job 1 and Job 2). As shown, Job 1 includes 10 workpieces in grid pattern 402 with two pockets 146A, 146B defined as empty or not accessible. Job 2 includes three, larger workpieces in grid pattern 404 with one pocket 146C defined as empty or not accessible. Similar to screen 342 of FIG. 16, screen 400 permits the operator to move from one drawer definition to another (icons 406, 408), to load a preexisting job file by clicking icon 410, to save the current job file by clicking icon 412, to select all pockets 146 to contain workpieces 148 instead of individually selecting each pocket by clicking icon 414, and to clear or deselect all pockets 146 (i.e., to set them as empty) by clicking icon 416.

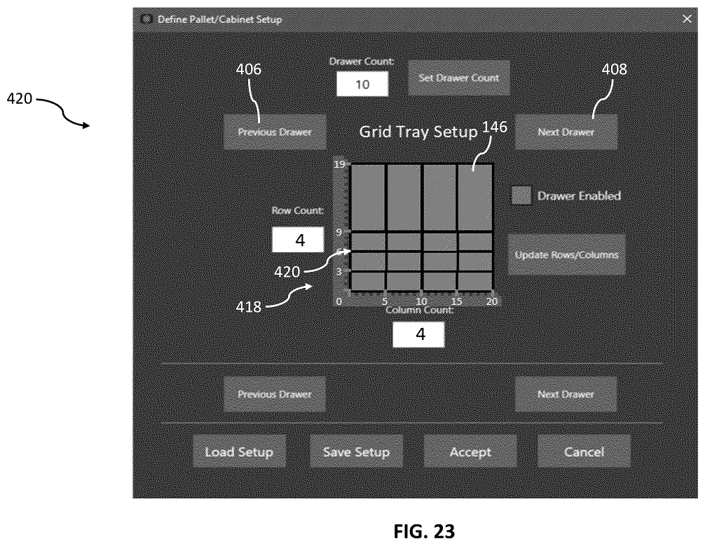

In an alternative embodiment, the operator may measure the three corners of grid tray 200 as described above with reference to FIGS. 19 and 20 and enter the locations 422 of the separation bars 216 in the job manager software as depicted in screen shot 420 of FIG. 23. The job manager software then displays the resulting grid tray 418. The operator can select any pockets 146 that must be blocked by clicking icon 409 of FIG. 22 to complete the set up. The operator then selects which job is located in each pocket 146 of the fully defined grid tray. The operator can select the Job program (CNC program to cut the part) using browse icon 411, and the robot program using browse icon 413. If there are multiple jobs programmed for a grid tray 200, then screen 400 shows which jobs are in what pocket as the job is programmed. Each job is sequentially labelled, in this case Job1 and Job 2. Loading and Saving a job will simply load in a previously saved job's data and fill the pockets that were saved if the pockets are available.

Since the bar positioning features 230 are evenly spaced on the grid tray 200, the job manager software can compute the location of any workpiece 148 based on its dimensions and location in the grid tray for robot 12 to pick and place accordingly. In a variation of this embodiment, each bar positioning feature 230 may be numbered on the grid tray with laser etching or otherwise to permit easier identification for entry into the job manager software. Additionally, bar positioning features 230 and the overall dimensions of the grid tray are user-defined parameters in the job manager software. FIG. 24 shows an example grid tray 200 configured for several different jobs using different sizes of workpieces 148.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

We claim:

1. A configurable tray for robot workpiece handling, comprising:
a frame including a plurality of frame segments arranged in a rectangle, each of the plurality of frame segments including a plurality of positioning features spaced evenly along an inner edge of the frame segment; and
a plurality of separation bars, each separation bar including a first end and a second end and configured to be selectively positioned within the frame such that the first end is positioned at a positioning feature of one of the frame segments and the second end is positioned at a positioning feature of another of the frame segments opposite the one of the frame segments;
wherein the plurality of separation bars are configured to be positioned to define one or more configurable grid patterns of pockets for receiving a workpiece by selectively positioning a first number of the plurality of separation bars between positioning features of a first pair of opposed frame segments of the plurality of frame segments and selectively positioning a second number of the plurality of separation bars overlapping the first number of the plurality of separation bars between positioning features of a second pair of opposed frame segments of the plurality of frame segments, the first pair of segments being perpendicular to the second pair of segments.

2. The configurable tray of claim 1, wherein the plurality of positioning features each includes a notch disposed between adjacent protrusions formed along the inner edge of the segment of the frame.

3. The configurable tray of claim 1, further including a base, the frame being attached to the base.

4. The configurable tray of claim 3, wherein the base includes a pair of end plates and a plurality of inner plates.

5. The configurable tray of claim 4, wherein the pair of end plates and the plurality of inner plates are configured to interlock to form the base.

6. The configurable tray of claim 1, wherein the plurality of frame segments includes a pair of side segments and a pair of end segments.

7. The configurable tray of claim 6, wherein each of the pair of side segments includes a first end forming a first notch and a second end forming a second notch, and each of the pair of end segments includes a first end forming a first tab and a second end forming a second tab, the first notches being configured to mate with the first tabs and the second notches being configured to mate with the second tabs, thereby connecting the pair of side segments to the pair of end segments to form the frame.

8. The configurable tray of claim 1, further including a pair of locking plates, each locking plate being attached to one of the plurality of frame segments and including an inner portion that overlaps the ends of the second number of the plurality of separation bars to clamp the plurality of separation bars in place.

9. The configurable tray of claim 8, further including a base attached to the frame and including a pair of end plates and a plurality of inner plates, wherein the plurality of frame segments, the plurality of separation bars, the pair of end plates, the plurality of inner plates, and the pair of locking plates are substantially the same length and substantially the same width.

10. The configurable tray of claim 1, further including a plurality of height adjustment brackets and a plurality of clips, wherein each height adjustment bracket is positioned adjacent a corner of the frame and includes a plurality of horizontal slots, and each of the plurality of clips is configured to extend through a pair of the plurality of horizontal slots and clip onto a frame segment, thereby supporting the frame at a selectable height above a support surface.

11. The configurable tray of claim 10, wherein each of the plurality of height adjustment brackets includes a mounting plate configured to attach to the support surface and an upright plate including the plurality of horizontal slots.

12. A robotic machine tending system, comprising:
a robot having at least one gripper for gripping a workpiece;
a controller configured to execute job manager software to control movement of the robot; and
a configurable tray configured to hold workpieces in one or more grid patterns of pockets;
wherein the configurable tray comprises:
a frame including a plurality of frame segments including a plurality of positioning features spaced evenly along an inner edge of the frame segment; and
a plurality of separation bars configured to be selectively positioned within the frame to define the one or more grid patterns of pockets by selectively positioning a first number of the plurality of separation bars between positioning features of a first pair of opposed frame segments of the plurality of frame segments and selectively positioning a second number of the plurality of separation bars overlapping the first number of the plurality of separation bars between positioning features of a second pair of opposed frame segments of the plurality of frame segments, the first pair of frame segments being perpendicular to the second pair of frame segments.

13. The robotic machine tending system of claim 12, wherein the plurality of positioning features each includes a notch disposed between adjacent protrusions formed along the inner edge of the frame segment.

14. The robotic machine tending system of claim 12, wherein the configurable tray further includes a base, the frame being attached to the base.

15. The robotic machine tending system of claim 14, wherein the base includes a pair of end plates and a plurality of inner plates, the pair of end plates and the plurality of inner plates being configured to interlock to form the base.

16. The robotic machine tending system of claim 12, wherein the plurality of frame segments includes a pair of side segments and a pair of end segments configured to mate with the pair of side segments to form the frame.

17. The robotic machine tending system of claim 12, wherein the configurable tray further includes a pair of locking plates, each locking plate being attached to one of the plurality of frame segments and including an inner portion that overlaps ends of the second number of the plurality of separation bars to clamps the plurality of separation bars in place.

18. The robotic machine tending system of claim 17, wherein the configurable tray further includes a base attached to the frame and including a pair of end plates and a plurality of inner plates, wherein the plurality of frame segments, the plurality of separation bars, the pair of end plates, the plurality of inner plates, and the pair of locking plates are substantially the same length and substantially the same width.

19. The robotic machine tending system of claim 12, wherein the configurable tray further includes a plurality of height adjustment brackets and a plurality of clips, wherein each height adjustment bracket is positioned adjacent a corner of the frame and includes a plurality of horizontal slots, and each of the plurality of clips is configured to extend through a pair of the plurality of horizontal slots and clip onto a frame segment, thereby supporting the frame at a selectable height above a support surface.

20. The robotic machine tending system of claim 12, wherein the job manager software causes the controller to display one or more grid tray configuration screens to enable an operator to define a number of rows and a number of columns corresponding to each of the one or more grid patterns.

21. The robotic machine tending system of claim 20, wherein the one or more configuration screens further enable the operator to define a length and a width of each of the one or more grid patterns.

22. The robotic machine tending system of claim 20, wherein the one or more configuration screens further enable the operator to define pockets of each of the one or more grid patterns that cannot be accessed by the robot.

23. A method for configuring a tray for robot workpiece handing, comprising:
selectively positioning a first plurality of separation bars within a corresponding first plurality of evenly spaced positioning features formed on a first pair of opposing frame segments of a frame;
selectively positioning a second plurality of separation bars within a corresponding second plurality of evenly spaced positioning features formed on a second pair of opposing frame segments of the frame, the second pair of opposing frame segments being perpendicular to the first pair of frame segments and the second plurality of separation bars overlapping the first plurality of separation bars; and
attaching a pair of locking bars to the second pair of opposing frame segments such that the locking bars overlap ends of the second plurality of separation bars to clamp the second plurality of separation bars in place.

24. The method of claim 23, further comprising:
assembling a base including a pair of end plates and a plurality of inner plates configured to interlock to form the base; and
attaching the frame to the base.

25. The method of claim 24, wherein attaching the frame to the base includes positioning the frame above the base and securing the frame to a plurality of height adjustment brackets connected to the base using a plurality of clips.
